(19) United States
(12) Patent Application Publication
(10) Pub. No.: US 2002/0145863 A1
(43) Pub. Date: Oct. 10, 2002

(54) Balloon light display

(76) Inventor: Margie Stultz, Vacaville, CA (US)

Correspondence Address: Margie Stultz, 931 Mustang Tr., Vacaville, CA, 95687, US

(21) Appl. No.: 09/828,435

(22) Filed: Apr. 9, 2001

(51) Int. Cl. F21V 33/00

(52) U.S. Cl. 362/96; 362/352; 362/234; 362/800; 362/231

(57) ABSTRACT

Balloon Light Display with a base plate and attached hollow housing, the housing enclosing a plurality of batteries, the housing also enclosing a microprocessor and associated electronics, the housing also enclosing a rubber bulb type air pump and associated check valves, the housing also enclosing and supporting an on-off switch, the housing also enclosing an optional air in port that allows the user to inflate a balloon using an external air pump, said housing also incorporating a removable and replaceable battery door, said housing acting as a base and attachment point for a centrally located, vertically disposed, support tube, said support tube attached at its lower end to said housing base and at its upper end to a balloon, said balloon being removable and replaceable, said balloon forming an air tight seal around the top of said support tube, said balloon preferably being translucent in construction, a plurality of electrical wires that attach at the lower end to said microprocessor, then travels within said support tube and terminating at the opposite end in a plurality of high intensity LED's, said LED's preferably being made up of a variety colors and an air tube attached at one end to said air pump, then traveling within said support tube and terminating within said balloon.

### BACKGROUND OF THE INVENTION

This invention relates generally to the field of lighting displays, and more particularly to a balloon light display.

Latex balloons are commonly used by people to help decorate an environment where a party or celebration of some sort is taking place. The balloons are traditionally colored. In recent times people have used helium to inflate the balloons so that they float. Ribbons or strings are then attached to the floating balloons so that they can be tied to each other or to a supporting structure. Balloons can also be inflated with air. The most simple way to inflate a balloon is for the user to place the open neck of the balloon into his or her mouth and blow air in. The user is essentially acting as a human air pump. One way to increase the festive appeal of a party balloon is to install a light of some sort into the balloon so that the light can be seen as it exits the translucent skin of the balloon. Others have proposed a form of lighted balloon display. However, prior attempts at creating a lighted balloon display have several deficiencies. First, an external air pumping mechanism is needed. The need for an external pump can prove problematic if the person using the lighted balloon display does not have an air pump. Additionally, there is no provision for a person to easily change the duration and sequence of a plurality of lights within a lighted balloon display.

### SUMMARY OF THE INVENTION

The primary object of the invention is to provide a display that employ's an inflated balloon that contains within it, a pulsating array of LED's.

Another object of the invention is to provide a lighted balloon display that includes a built in air pump in its base.

Another object of the invention is to provide a lighted balloon display where the user can choose between a plurality of LED pulsating effects.

A further object of the invention is to provide a lighted balloon display where the base of said display includes a plurality of retaining hooks that allow the user to affix a plurality of ribbons and attached helium balloons.

Yet another object of the invention is to provide a lighted balloon display where a flexible, hollow tube portion holds the lit balloon in the air as well as being a conduit for electrical wires and an air inflation tube.

Other objects and advantages of the present invention will become apparent from the following descriptions, taken in connection with the accompanying drawings, wherein, by way of illustration and example, an embodiment of the present invention is disclosed.

Balloon Light Display comprising: a base plate and attached hollow housing, said housing enclosing a plurality of batteries, said housing also enclosing a microprocessor and associated electronics, said housing also enclosing a rubber bulb type air pump and associated check valves, said housing also enclosing and supporting an on-off switch, said housing also enclosing an optional air in port that allows the user to inflate a balloon using an external air pump, said housing also incorporating a removable and replaceable battery door, said housing acting as a base and attachment point for a centrally located, vertically disposed, support tube, said support tube attached at its lower end to said housing base and at its upper end to a balloon, said balloon being removable and replaceable, said balloon forming an air tight seal around the top of said support tube, said balloon preferably being translucent in construction, a plurality of electrical wires that attach at the lower end to said microprocessor, then travels within said support tube and terminating at the opposite end in a plurality of high intensity LED's, said LED's preferably being made up of a variety colors and an air tube attached at one end to said air pump, then traveling within said support tube and terminating within said balloon.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a side section view of the balloon light of the present invention.

FIG. 2 is a perspective view of the balloon light of the present invention.

FIG. 3 is a bottom view of the base housing balloon light of the present invention.

FIG. 4 is a schematic of the the circuit of the balloon light of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

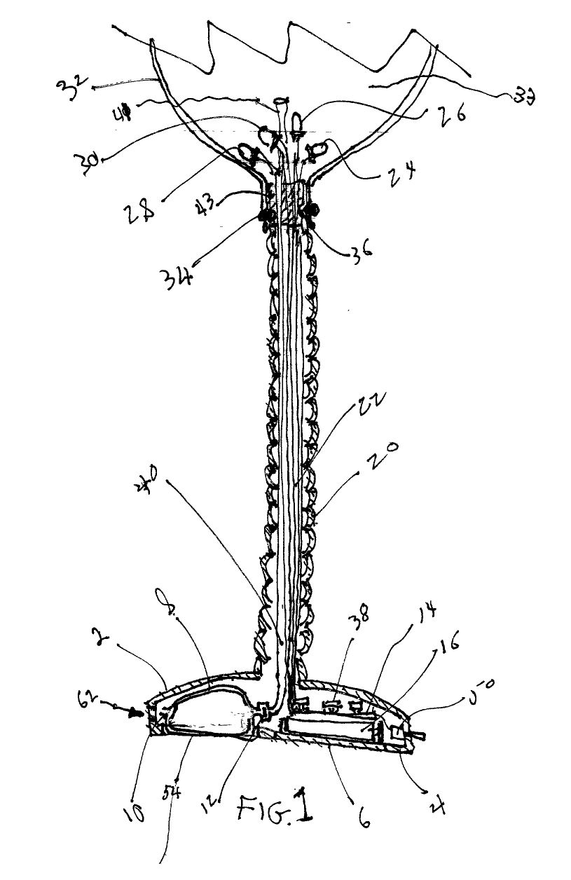

Referring now to FIG. 1 we see a side section view of the balloon light of the present invention, A hollow base housing is comprised of a top cover 2 that includes a dome shaped top and integral side walls, and a bottom plate 4. within the base housing is a rubber bulb type air pump 8 that includes standard check valves at the air inlet 10 and air outlet 12 thereby creating a pumping action when the user pushes rubber bulb 8 in at exposed portion 54. Also contained within the base housing are battery power supply 16, on off switch 50, printed circuit board 14 and microprocessor electronics 38. An air tube 40 runs from the air pump 8 up through balloon support tube 20 and then through upper plug 43 and terminates in internal balloon area 33. The fit between air tube 40 and plug 43 is air tight. Similarly, electrical wires 22 travel from microprocessor 38 up balloon support tube 20 and terminate at colored LED's 24, 26, 28, 30 located in internal balloon area 33. the neck of balloon 32 is removably fastened to upper plug 43 at point 36. An O ring helps restrict air from escaping from balloon 32. To use the balloon light of the present invention, the user places the neck of a translucent type latex balloon 32 onto upper plug 43 and then places O ring 34 around the neck of the balloon. The user then pumps up the balloon by repeatedly pressing on the rubber bulb at area 54. Alternately, the user can elect to attach a standard air pump at air inlet 62 and inflate the balloon in the standard manner. The user then turns on switch 50 thereby activating microprocessor 38 which causes LED's 24, 26, 28, 30 to flash in a preprogrammed sequence. The user, by turning off switch 50 and turning it back on again, can change the flashing to a new sequence. This process of turning switch 50 on, off and on again causes the duration of light and the order of lighting of each LED to change. There can be a plurality of set lighting patterns, each pattern being triggered by the process turning switch 50 off then on again. Because balloon 32 is translucent, the light from LED's 24, 26, 28, 30 can be seen externally, thereby creating a festive appearance for use at a party or other similar event. The LED's are of a special high brightness type, 2000 Mcd, that produce a bright enough light as to be easily seen by those in close proximity to the balloon 32.

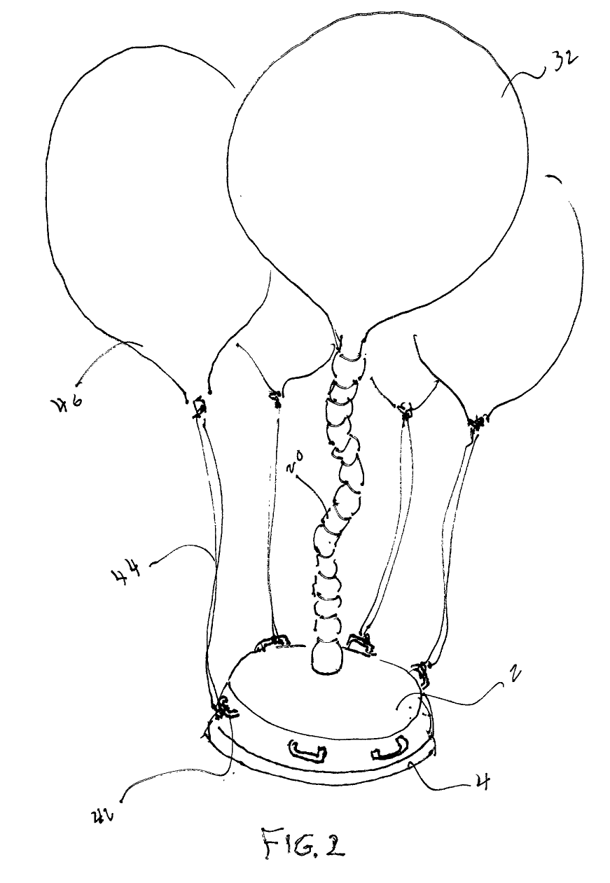

FIG. 2 shows a perspective view of the balloon lighting display of the present invention. Base housing 2 includes a plurality of balloon string retaining members 42 that can receive and retain balloon strings 44 that in turn retain helium filled balloons 46. In the preferred embodiment, balloon support tube 20 is comprised of a plurality of interlocking members that snap together. Similar tubes can be found in flexible coolant hose assemblies found in industrial applications. The tube 20 can be bent by the user and can then retain its bent shape until the user re-bends the tube 20 to a new shape.

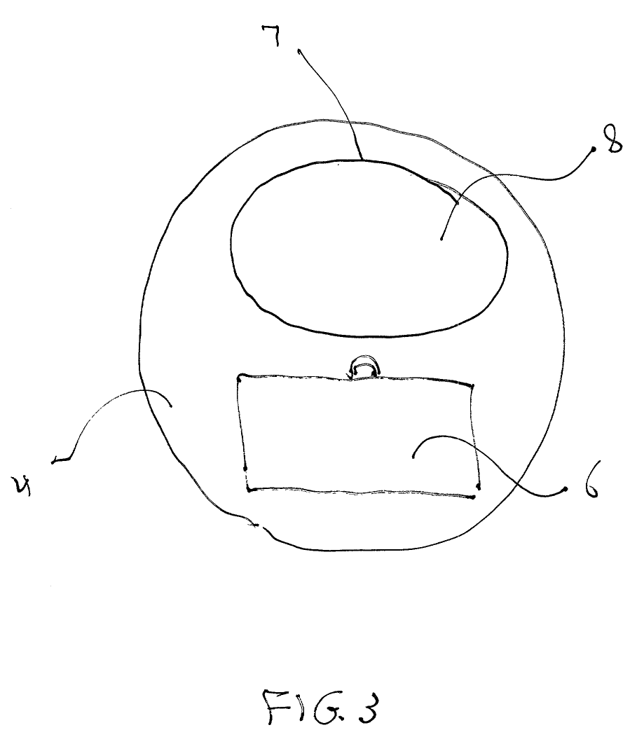

FIG. 3 shows a bottom view of base plate 4. In this view one can clearly see the cut out section 7 that exposes a portion of rubber bulb 8 thereby allowing the user to push in the rubber 8 causing the pumping effect already described. Battery door 6 can also be seen.

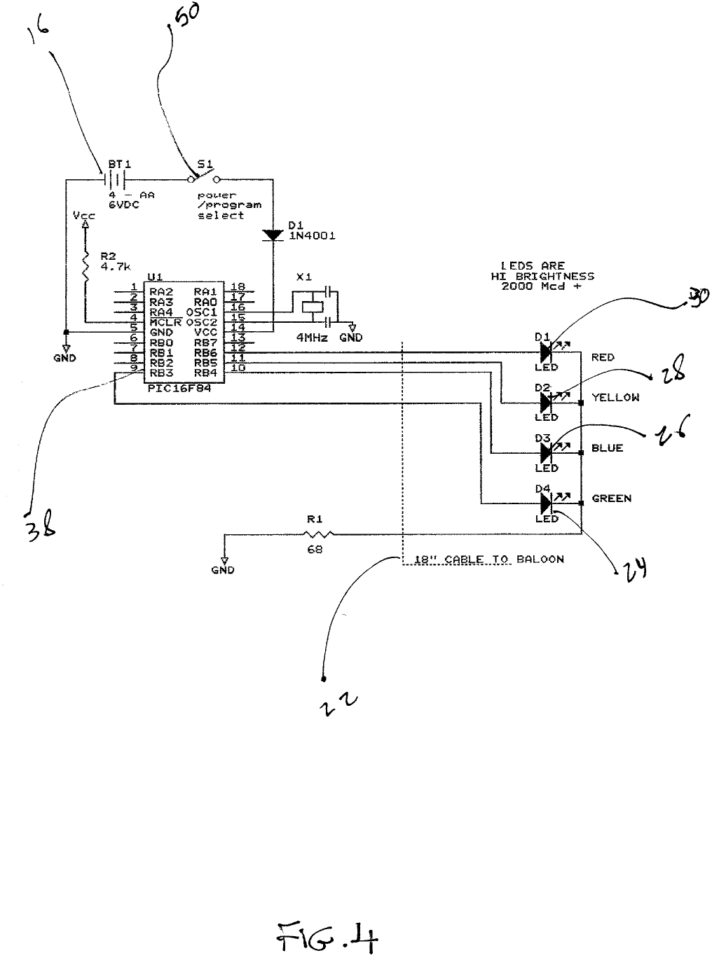

FIG. 4 is a schematic drawing of the electronic circuit of the present invention,

In the above described and illustrated way, a person can add a festive element to a party or the like by using the lighted balloon display of the present invention. The user can easily blow up the balloon by using the rubber bulb pump that is incorporated within the base of the display. Additional string retaining members can secure a plurality of helium balloons to the base thereby increasing the festive effect. The sequence and duration of the lighting display can be easily changed when the user turns the display off and then on again.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Balloon Light Display comprising:
a base plate and attached hollow housing;
said housing enclosing a plurality of batteries;
said housing also enclosing a microprocessor and associated electronics;
said housing also enclosing a rubber bulb type air pump and associated check valves;
said housing also enclosing and supporting an on-off switch;
said housing also enclosing an optional air in port that allows the user to inflate a balloon using an external air pump;
said housing also incorporating a removable and replaceable battery door;
said housing acting as a base and attachment point for a centrally located, vertically disposed, support tube;
said support tube attached at its lower end to said housing base and at its upper end to a balloon;
said balloon being removable and replaceable;
said balloon forming an air tight seal around the top of said support tube;
said balloon preferably being translucent in construction;
a plurality of electrical wires that attach at the lower end to said microprocessor, then travels within said support tube and terminating at the opposite end in a plurality of high intensity LED's;
said LED's preferably being made up of a variety colors and
an air tube attached at one end to said air pump, then traveling within said support tube and terminating within said balloon.

2 Balloon Light Display as claimed in claim 1 wherein said on-off switch causes said LED's to light in a pulsating manner and to be observable through the translucent skin of said inflated balloon,

3 Balloon Light Display as claimed in claim 1 wherein the pulsations of said LED display can be varied by operating the on-off switch, each on-off cycle producing a different arrangement and duration of pulsations.
